(19) United States
(12) Patent Application Publication
(10) Pub. No.: US 2018/0371207 A1
(43) Pub. Date: Dec. 27, 2018

(54) POLYMER COMPOSITE COMPOSITIONS INCLUDING HYDROUS KAOLIN

(71) Applicant: Imerys USA, Inc., Roswell, GA (US)

(72) Inventors: David W. DEWULF, Johns Creek, GA (US); Chinmay PESHAVE, Milledgeville, GA (US); Ioannis POULAKIS, St. Simons Island, GA (US)

(21) Appl. No.: 16/061,702

(22) PCT Filed: Dec. 14, 2016
(86) PCT No.: PCT/US16/66653

§ 371 Date: Jun. 13, 2018

Related U.S. Application Data
(60) Provisional application No. 62/267,469, filed on Dec. 15, 2015.

(51) Int. Cl. C08K 3/34; C08K 7/10; C08K 7/14; C08K 9/06; C08L 79/08; C08L 77/00; C08L 81/04; C08L 67/00

(52) U.S. Cl. CPC C08K 3/346; C08K 7/10; C08K 7/14; C08K 9/06; C08K 2201/005; C08L 77/00; C08L 81/04; C08L 67/00; C08L 79/08

(57) ABSTRACT

A polymer composite composition for manufacturing an article may include hydrous kaolin, an acicular material, and a polymer that may include at least one of nylons, polyesters, polyimides, polyamides, aromatic polyamides, polysulfides, polyetherketones, polycarbonates, or polyolefins. The hydrous kaolin, acicular material, and polymer may be combined to form the polymer composite composition. A method of reducing acicular material in a polymer composite composition including the acicular material and a polymer while maintaining a flexural modulus of an article including the polymer composite composition, may include substituting hydrous kaolin for at least a portion of the acicular material in the polymer composite composition.

### CLAIM FOR PRIORITY

This PCT International Application claims the benefit of priority of U.S. Provisional Application No. 62/267,469, filed Dec. 15, 2015, the subject matter of which is incorporated herein by reference in its entirety.

### FIELD OF THE DESCRIPTION

The present disclosure relates to polymer composite compositions, and more particularly, to polymer composite compositions including hydrous kaolin.

### BACKGROUND

Many thermoplastic articles of manufacture are formed from plastic materials sometimes referred to as “engineering thermoplastics.” Engineering thermoplastics may include polymers such as nylons, polyesters, aromatic polyamides, polysulfides, polyetherketones, polycarbonates, or polyolefins. Engineering thermoplastics may be used to form articles for which desirable characteristics may include high stiffness, resistance to solvents, barrier properties, high reflectivity surfaces, heat resistance, high impact strength, and/or resistance to creep. In order to enhance the strength or other desired characteristics of the articles formed from engineering thermoplastics, glass fibers may be incorporated into the polymers to form a composite material. However, the inclusion of glass fibers in engineering thermoplastics may have several drawbacks. For example, glass fibers may be relatively expensive, difficult to process, and sometimes adversely affect the surface qualities of the finished article.

Therefore, it may be desirable to provide alternative compositions and methods that provide at least some of the benefits adding glass fibers to polymers while reducing or eliminating the glass fibers. The compositions and methods disclosed herein may mitigate or overcome one or more of the possible drawbacks described above, as well as other possible drawbacks.

### SUMMARY

According to one aspect, a polymer composite composition for manufacturing an article may include hydrous kaolin, an acicular material, and a polymer that may include at least one of nylons, polyesters, polyimides, polyamides, aromatic polyamides, polysulfides, polyetherketones, polycarbonates, and polyolefins. The hydrous kaolin, acicular material, and polymer may be combined to form the polymer composite composition.

According to another aspect, a method of reducing acicular material in a polymer composite composition including the acicular material and a polymer while maintaining a flexural modulus of an article including the polymer composite composition, may include substituting hydrous kaolin for at least a portion of the acicular material in the polymer composite composition.

It is to be understood that both the foregoing general description and the following detailed description are exemplary and explanatory only and are not restrictive of the invention, as claimed.

### BRIEF DESCRIPTION OF THE DRAWINGS

FIG. 1 is a graph showing Young's modulus (GPa) vs. wt % of exemplary kaolin for fifteen samples of exemplary polymer composite compositions.

FIG. 2 is a graph showing ultimate tensile strength (UTS) (MPa) vs. wt % of exemplary kaolin for the fifteen samples of exemplary polymer composite compositions.

FIG. 3 is a graph showing elongation at break (mm) vs. wt % of exemplary kaolin for the fifteen samples of exemplary polymer composite compositions.

FIG. 4 is a graph showing flexural modulus (GPa) vs. wt % of exemplary kaolin for the fifteen samples of exemplary polymer composite compositions.

FIG. 5 is a graph showing flexural strength (MPa) vs. wt % of exemplary kaolin for the fifteen samples of exemplary polymer composite compositions.

FIG. 6 is a graph showing impact strength (ft-lb/in²) vs. wt % of exemplary kaolin for the fifteen samples of exemplary polymer composite compositions.

### DESCRIPTION OF EXEMPLARY EMBODIMENTS

According to some embodiments, a polymer composite composition for manufacturing an article may include hydrous kaolin, an acicular material, and a polymer that may include at least one of nylons, polyesters, polyimides, polyamides, aromatic polyamides, polysulfides, polyetherketones, polycarbonates, and polyolefins. The hydrous kaolin, acicular material, and polymer may be combined to form the polymer composite composition. According to some embodiments, the polymer may include polyamides.

As used herein, “acicular” refers to particulates including, or derived from, slender, needle-like structures or crystals, or particulates having a similar form. According to some embodiments, the acicular material may include fiber. For example, the acicular material may include chopped fiber. According to some embodiments, the acicular material may include glass fiber, such as, for example, chopped glass fiber. According to other embodiments, the acicular material may include wollastonite. The glass may include silica or silicate and one or more of oxides of calcium, magnesium, and boron.

The morphology of a particulate may be characterized by “shape factor.” As used herein, “platy” refers to particulates having a shape factor greater than 1. in contrast, particulates having a shape factor less than or equal to 1 would be considered to have a “blocky” morphology.

“Shape factor” as used herein is a measure of an average value (on a weight average basis) of the ratio of mean particle diameter to particle thickness for a population of particles of varying size and shape, as measured using the electrical conductivity method according to the description in U.S. Pat. No. 5,576,617, the subject matter of which is incorporated herein by reference, an apparatus may be used to measure the shape factor of non-spherical particles by obtaining a fully-deflocculated suspension of the particles, causing the particles in the suspension to orientate generally in a first direction, measuring the conductivity of the particles suspension substantially in the first direction, and simultaneously or substantially simultaneously measuring the conductivity of the particle suspension in a direction transverse to the first direction. Thereafter, the difference between the two conductivity measurements may be determined to provide a measure of the shape factor of the particles in suspension. Measuring conductivity “substantially simultaneously” means to take the second conductivity measurement sufficiently close in time after the first conductivity measurement, such that the temperature of the suspension being measured will be effectively the same for each measurement.

According to some embodiments, the hydrous kaolin may include platy hydrous kaolin. For example, the hydrous kaolin may have a shape factor of at least 10. For example, the shape factor may be at least 20, at least 30, at least 40, at least 50, at least 60, at least 70, or at least 80. According to some embodiments, the shape factor of the hydrous kaolin may range from 10 to 70, from 10 to 60, from 10 to 50, from 10 to 40, from 20 to 70, from 20 to 60, from 20 to 50, from 20 to 40, from 30 to 70, from 30 to 60, from 30 to 50, from 30 to 40, from 40 to 70, from 40 to 60, from 40 to 50, from 50 to 70, from 50 to 60, or from 60 to 70.

According to some embodiments, the hydrous kaolin may include surface-treated hydrous kaolin. For example, the hydrous kaolin may include hydrous kaolin surface-treated with at least one of silanes, amino silanes, silicates, silicone fluids, emulsions, and siloxanes. According to some embodiments, the hydrous kaolin may include hydrous kaolin surface-treated with amino silanes.

According to some embodiments, the polymer composite composition may include at least 10 wt % hydrous kaolin relative to the total weight of the composition. For example, the polymer composite composition may include at least 20 wt % hydrous kaolin, at least 30 wt % hydrous kaolin, at least 40 wt % hydrous kaolin, or at least 50 wt % hydrous kaolin relative to the total weight of the cornposition.

Particle sizes and other particle size properties referred to in the present disclosure may be measured using a Sedigraph 5100 instrument, as supplied by Micromeritics Corporation. Using such a measuring device, the size of a given particle is expressed in terms of the diameter of a sphere of equivalent diameter, which sediments through the suspension, sometimes referred to as “an equivalent spherical diameter” or “esd.” The median particle size, or the “d₅₀” value, is the value determined by the particle esd at which 50% by weight of the particles have an esd less than the d₅₀ value. Other methods and/or devices for determining particle size and related properties are contemplated.

According to some embodiments, the median particle size d₅₀ of the hydrous kaolin may be less than or equal to 2 microns. For example, the median particle size d₅₀ of the hydrous kaolin may be less than or equal to 1.5 microns, less than or equal to 1.4 microns, less than or equal to 1.3 microns, less than or equal to 1.2 microns, less than or equal to 1.1 microns, less than or equal to 1.0 micron, less than or equal to 0.9 microns, less than or equal to 0.8 microns, less than or equal to 0.7 microns, less than or equal to 0.6 microns, less than or equal to 0.5 microns, less than or equal to 0.4 microns, less than or equal to 0.3 microns, or less than or equal to 0.2 microns. According to some embodiments, the median particle size d₅₀ of the hydrous kaolin may be less than or equal to 0.5 microns (e.g., less than 0.3 microns) and the hydrous kaolin may include hydrous kaolin surface-treated with amino silanes.

According to some embodiments, a polymer composite composition for manufacturing an article may include hydrous kaolin and a polymer that may include at least one of nylons, polyesters, polyimides, polyamides, aromatic polyamides, polysulfides, polyetherketones, polycarbonates, or polyolefins. The hydrous kaolin and polymer may be combined to form the polymer composite composition. An article including the polymer composite composition including the hydrous kaolin may have a flexural modulus higher than the article including the polymer composite composition devoid of the hydrous kaolin.

According to some embodiments, an article including the polymer composite composition including the hydrous kaolin may have a flexural modulus at least 10% higher than the article including the polymer composite composition devoid of the hydrous kaolin. For example, the article including the polymer composite composition including the hydrous kaolin may have a flexural modulus at least 25% higher than the article including the polymer composite composition devoid of the hydrous kaolin. According to some embodiments, the article including the polymer composite composition including the hydrous kaolin may have a flexural modulus at least 40% higher than the article including the polymer composite composition devoid of the hydrous kaolin.

A method of reducing acicular material in a polymer composite composition including the acicular material and a polymer while maintaining a flexural modulus of an article including the polymer composite composition, may include substituting hydrous kaolin or kaolin having a median particle size d₅₀ of less than 0.5 microns, for at least a portion of the acicular material in the polymer composite composition. According to some embodiments, the substituting may include substituting the hydrous kaolin or kaolin having a median particle size d₅₀ of less than 0.5 microns, for the at least a portion of acicular material at least a 1:1 ratio of hydrous kaolin to acicular material based on weight. According to some embodiments, the substituting may include substituting the hydrous kaolin for the at least a portion of acicular material at a ratio of hydrous kaolin to acicular material based on weight ranging from 1:4 to 4:1, from 1:3 to 3:1, or from 1:2 to 2:1.

According to some embodiments of the method, the hydrous kaolin may include platy hydrous kaolin or kaolin having a median particle size d₅₀ of less than 0.5 microns, and the substituting may include substituting the platy hydrous kaolin or kaolin having a median particle size d₅₀ of less than 0.5 microns for the at least a portion of acicular material. For example, the hydrous kaolin may have a shape factor of at least 10. For example, the shape factor may be at least 20, at least 30, at least 40, at least 50, at least 60, at least 70, or at least 80. According to some embodiments, the shape factor of the hydrous kaolin may range from 10 to 70, from 10 to 60, from 10 to 50, from 10 to 40, from 20 to 70, from 20 to 60, from 20 to 50, from 20 to 40, from 30 to 70, from 30 to 60, from 30 to 50, from 30 to 40, from 40 to 70, from 40 to 60, from 40 to 50, from 50 to 70, from 50 to 60, or from 60 to 70.

According to some embodiments of the method, the hydrous kaolin may include surface treated hydrous kaolin, and the substituting may include substituting the surface treated hydrous kaolin for the at least a portion of acicular material. For example, the hydrous kaolin may include hydrous kaolin surface-treated with at least one of silanes, amino silanes, silicates, silicone fluids, emulsions, and siloxanes. According to some embodiments, the hydrous kaolin may include hydrous kaolin surface-treated with amino silanes.

According to some embodiments of the method, the acicular material may include fibers, and the substituting may include substituting the hydrous kaolin for at least a portion of the fibers. For example, the acicular material may include glass fibers, and the substituting may include substituting the hydrous kaolin for at least a portion of the glass fibers. According to some embodiments of the method, the acicular material may include chopped glass fibers, and the substituting may include substituting the hydrous kaolin for at least a portion of the chopped glass fibers.

According to some embodiments of the method, the polymer may include at least one of nylons, polyesters, polyimides, polyamides, aromatic polyamides, polysulfides, polyetherketones, polycarbonates, and polyolefins. For example, the polymer may include polyamides.

The kaolin may be prepared by light comminution (e.g., grinding and/or milling) of a coarse kaolin to give suitable delamination thereof. The comminution may be carried out by use of beads or granules of a plastic (e.g., nylon, grinding, and/or milling aid). Ceramic media such as silica and/or sand may also be used. In order to improve the dispersion of the kaolin in, for example, polymers, jet-milling and/or fluid energy milling may be used. U.S. Pat. No. 6,145,765 and U.S. Pat. No. 3,932,194 may provide examples of such processes. The coarse kaolin may be refined to remove impurities and improve physical properties using well-known procedures. The kaolin may be treated by a known particle size classification procedure, such as, for example, screening and/or centrifuging, to obtain particles having a desired median particle size d₅₀ value.

The kaolin may be surface-treated with one or more compounds, which may be selected from organic and/or inorganic compounds. These compounds may be referred to herein as surface-treatment agents. The surface treatment may generally seek to neutralize and/or reduce the activity of acid sites on the surface of the kaolin, thereby stabilizing and preferably increasing the effective lifetime of the polymer composite compositions in which the kaolins are incorporated. The neutralization of the acid sites results in a so-called passivation of the kaolin and in certain circumstances, increased hydrophobicity.

The term “surface-treatment” used herein is to be understood broadly, and is not limited to, for example, uniform coatings and/or to coatings that cover the entire surface area of a particle. Particles for which discrete regions of the surface are modified with a surface-treatment agent, and for which areas of the surface are associated with discrete molecules of the surface-treatment agent, will be understood as being surface-modified within the terms of the present application. The compound may suitably be present in an amount sufficient to reduce the activity of and/or passivate surface acid sites of the kaolin. For example, the compound may be present in an amount ranging from 0.1 wt % to 10 wt % based on the weight of the coated particulate kaolin material. For example, the compound may be present in an amount ranging from 0.1 wt % to 3 wt %, such as, for example, from 0.5 wt %, 0.6 wt %, or 0.7 wt % and 2.0 wt % (e.g., 1.5 wt %). To a certain extent, this may depend on the surface area of the kaolin but, typically, the coating level (in milligrams (mg)) of surface-treatment agent per surface area (in square meters (m²)) of dry kaolin clay may range from 0.05 mg/m² to 8 mg/m², for example, from 0.08 mg/m² to 6 mg/m², or from 0.1 mg/m² to 2 mg/m².

The particles of the kaolin usable in the present disclosure may preferably have a specific surface area (e.g., as measured by the BET liquid nitrogen absorption method ISO 5794/1) of at least 5 m²/g, for example, at least 15 m²/g, at least 20 mg²/g, at least 25 m²/g, or from 10 to 40 m²/g.

The surface-treatment agent may be polymeric or non-polymeric. The surface treatment agent may include at least one functional group that can interact with a polymer or other material to be filled using the kaolin (e.g., a high shape factor hydrous kaolin). When the surface-treatment includes the use of one or more organic compounds, then the one or more organic compounds may include an organic portion and a basic portion. The organic portion of the compound may include a straight- or branched-chain alkyl group having at least three carbon atoms, such as, for example, between eight and twenty-four carbon atoms, such as, for example, a C₁₃, C₁₄, C₁₅, C₁₆, C₁₇, C₁₈, C₁₉, C₂₀, C₂₁, C₂₂, or C₂₃ alkyl group. Alternatively, the organic portion may include one or more cyclic organic groups, which may be saturated, unsaturated, or aromatic, and which may include one or more heteroatoms, such as, for example, O, N, S, and Si. The cyclic organic group may include, for example, at least one six-membered ring. The organic portion of the compound may include one or more substituent groups, such as, for example, functional groups that may cooperatively interact with a polymeric material to be filled using the surface-treated kaolin particles. The interaction may involve, for example, covalent bonding, cross-linking, hydrogen bonding, chain entanglement, or ionic interaction. Functional substituent groups may include, for example, polar or non-polar groups, and hydrophobic or hydrophilic groups. Examples of such groups include amide or polyamide groups, which may cooperatively interact with polyamides such as nylon, carboxyl groups, vinyl groups, which may cooperatively interact with natural or synthetic rubbers, mercapto, or other sulphur-containing groups, which may cooperatively interact with natural or synthetic rubbers, or alkylamino groups, such as ethylamino or propylamino groups. The organic compound may be monomeric or polymeric. The term “polymeric” includes homopolymers and copolymers. The organic compound may be selected from one or more saturated or unsaturated C₃-C₂₄ fatty acids, such as, for example, C₈-C₂₄, stearic acid (C₁₈) or behenic acid (C₂₂).

The basic portion of the compound may include any group that is capable of associating with the acid sites of the kaolin particles. The basic portion may include, for example, at least one primary, secondary, or tertiary amine group. The basic portion of the organic compound may include one or more primary amine group NH₂.

The organic compound may be selected from, for example, alkyl mono-amines containing between eight and twenty-four carbon atoms in a straight- or branched-alkyl portion (e.g., hydrogenated-tallowalkyl-amine), organic polyamines, and cyclic mono- or poly-amines including at least one cyclic ring system having at least six atoms including the ring (e.g., melamine). These compounds may carry further functional substituents on the organic portion, for example, as described above. Examples of such organic compounds include amino alcohols, such as, for example, 2-amino-2-methyl-1-propanol. A suitable commercially available amino alcohol is AMP-95®, which is a formulation of 2-amino-2-methyl-1-propanol containing 5% water.

Suitable organic amine compounds for use as surface-treatment agents may be characterized by, for example, the following formula I:

R—NR₁R₂ (I)

where R may be selected from C₈-C₂₄ straight- or branched-chain alkyl groups and R₁ and R₂ may be selected independently from one another from H, C₈-C₂₄ straight- or branched-chain alkyl groups. According to some embodiments, at least one of R₁ and R₂ may be H.

According to some embodiments, the hydrous kaolin may be surface-treated with one or more of siloxanes, silicone fluids, oligomeric and/or polymeric emulsions, hexadecyltrimethoxysilane, and ployethyleglycol alkoxysilane. For example, siloxanes may include, but are not limited to, dimethylpolysiloxane fluids and/or hydroxyl terminated linear polydimethylsiloxane fluid. Suitable siloxanes may also include linear and cyclic siloxane oligomers, and/or polysiloxanes. Silicone fluid treatments may include, but are not limited to, wax emulsions, including natural, semi-synthetic, and synthetic waxes, for example, dispersed in a liquid carrier such as water or organic solvents, micronized waxes in powder form, and/or emulsions. Oligomeric and/or polymeric emulsions may include a high-density oxidized PE homopolymer, and/or an oxidized PE homopolymer. A suitable hexadecyltrimethoxysilane may have hydrophobe and wetting functionality. A suitable phenyltrimethoxysilane may have hydrophobe functionality. A suitable polyethyleneglycol alkoxysilane may have wetting functionality.

According to some embodiments, the surface-treatment may include use of one or more inorganic compounds. For such embodiments, the one or more inorganic compounds may include silicon containing compounds, such as, for example, silanes, amino silanes, and silicates. Suitable aminosilanes include, for example, trimethoxysilyl ethyl amine, triethoxysilyl ethyl amine, tripropoxysilyl ethyl amine, tributoxysilyl ethyl amine, trimethoxysilyl propyl amine, triethoxysilyl propyl amine, tripropoxysilyl propyl amine, triisopropoxysilyl propyl amine, tributoxysilyl propyl amine, trimethoxysilyl butyl amine, triethoxysilyl butyl amine, tripropoxysilyl butyl amine, tributoxysilyl butyl amine, trimethoxysilyl pentyl amine, triethoxysilyl pentyl amine, tripropoxysilyl pentyl amine, tributoxysilyl pentyl amine, trimethoxysilyl hexyl amine, triethoxysilyl hexyl amine, tripropoxysilyl hexyl amine, tributoxysilyl hexyl amine, trimethoxysilyl heptyl amine, triethoxysilyl heptyl amine, tripropoxysilyl heptyl amine, tributoxysilyl heptyl amine, trimethoxysilyl octyl amine, triethoxysilyl octyl amine, tripropoxysilyl octyl amine, tributoxysilyl octyl amine, and/or similar aminosilanes. Other possible inorganics include inorganic dispersants such as phosphates, such as, for example, sodium hexametaphosphate, tetrasodium pyrophosphate, and/or sulphate-based compounds such as alum.

The surface-treated kaolin (e.g., hydrous kaolin) may be obtained by contacting a particulate kaolin having the desired shape factor with the one or more surface-treatment agents under conditions whereby the surface-treatment agent will associate with the surface of the kaolin particles. The compound may be intimately admixed with the particles of the kaolin to improve contact between the materials. Both wet and dry conditions may be used, and the surface treatment agent may be used in the form of solid particles (e.g., prills) or may be entrained in a solvent for the coating process. The coating process may be carried out at an elevated temperature.

In addition to being surface treated with a surface treatment agent, according to some embodiments, the kaolin may be subjected to a secondary treatment. The secondary treatment may include the use of one or more of the treatment agents described in relation to surface treatment, such as, for example, inorganic compounds possessing a hydrophobic portion, such as the silanes and/or aminosilanes. Other secondary treatment agents, which may be referred to herein as “secondary passivants,” may include one or more of the following: antioxidants such as phenol-based antioxidants; resins such as low or medium weight epoxy resins; dispersants such as kaolin dispersants; polymers such as polyacrylates that have been hydrophobically modified; copolymers such as ethylene copolymers of polacrylic acid; and/or lubricants such as polyethylene waxes and silicone oils.

According to some embodiments, the polymer composite compositions for use in polymer articles may also include additives, such as, for example, dispersants, cross linkers, water retention aids, viscosity modifiers or thickeners, lubricity aids, antifoamers/defoamers, dry or wet rub improvement or abrasion resistance additives, optical brightening agents, whitening agents, dyes, and/or biocides.

The polymer included in the polymer composite composition may include any natural or synthetic polymer or mixture thereof. The polymer may be, for example, a thermoplastic or a thermoset. The term “polymer” used herein includes homopolymers and copolymers, as well as crosslinked and/or entangled polymers and elastomers such as natural or synthetic rubbers and mixtures thereof. Specific examples of suitable polymers include, but are not limited to, polyolefins of any density such as polyethylene and polypropylene, polycarbonate, polystyrene, polyester, acrylonitrile-butadiene-styrene copolymer, nylons, polyurethane, ethylene-vinylacetate polymers, ethylene vinyl alcohol, polyvinylidene chloride, polyethylene terephthalate (PET), polybutylene terephthalate (PBT) and mixtures thereof, both cross-linked or un-cross-linked.

In a certain embodiment the polymer may comprise polyethylene terephthalate (PET), Polybutylene terephthalate (PBT), or mixtures thereof. Such PET and/or PBT polymer or mixtures can further comprise a hydrophobe silane, a reactive silane, or mixtures thereof. Such silanes include those that are commonly found in the industry.

Thermoplastic polymers are suitable for use in the production of polymer composite composition articles. Examples include polyolefins, such as, polyethylene, polypropylene, and cyclic olefin copolymers. Low density polyethylene (LDPE) may be formed, for example, using high temperature and high pressure polymerization conditions. The density is low because these polymerization conditions give rise to the formation of many branches, which may be relatively long and prevent the molecules from packing close together to form crystal structures. Hence LDPE has low crystallinity (typically below 40%), and the structure is predominantly amorphous. The density of LDPE is taken to be in the range of about 0.910 to 0.925 g/cm³. Other suitable types of polyethylene include high density polyethylene (HDPE), linear low density polyethylene (LLDPE), and ultralow density polyethylene (ULDPE). The densities of these materials may fall within the following ranges: HDPE from 0.935 to 0.960 g/cm³; LLDPE from 0.918 to 0.940 g/cm³; and ULDPE from 0.880 to 0.915 g/cm³.

According to certain embodiments, the polyamides may be selected from the group consisting of PA66, PA6, PA11, PA66/6, PA6/66, PA46, PA612, PA12, PA610, PA6I/6T, PA6I, PA9T, PADT, PAD6 (D=2-methyl-1,5-diaminopentane), and PA7, and/or combinations thereof, including copolymers.

The term “precursor” is used herein in a manner understood by those skilled in the art. For example, suitable precursors may include one or more of monomers, cross-linking agents, curing systems including cross-linking agents and promoters, or any combination thereof. According to some embodiments, the kaolin material may be mixed with precursors of the polymer, and the polymer composition may be thereafter formed by curing and/or polymerizing the precursor components to form the desired polymer.

In some embodiments including thermoplastic polymers, the polymer resin may be melted (or otherwise softened) prior to formation of the final article, and the polymer may not be subjected to any further chemical transformations. After formation of the final article, the polymer resin may be cooled and allowed to harden.

The thermoplastic polymer composition may be made by methods known in the art. In some embodiments, the kaolin and surface-treatment agent may be combined prior to mixing with the polymer. Similarly, certain ingredients may, if desired, be pre-mixed before addition to the compounding mixture. For example, if desired, a coupling agent may be pre-mixed with the surface-treated hydrous kaolin before addition of the kaolin to the mixture. The surface-treated hydrous kaolin and the polymer resin may be mixed together in suitable ratios to form a blend, sometimes referred to as “compounding.” The polymer resin may be in a liquid form, which may enable the particles of the kaolin to be dispersed therein. Where the polymer resin is solid at ambient temperatures, the polymer resin may be melted before the compounding is performed. In some embodiments, the hydrous kaolin may be dry blended with particles of the polymer resin, and the particles may be dispersed in the resin when the melt is obtained prior to forming an article from the melt, for example, via an extruder.

In some embodiments, the polymer resin, the kaolin, and any other additives may be formed into a suitable masterbatch by the use of a suitable compounder/mixer in a manner known, and may be pelletized via, for example, a single screw extruder or a twin-screw extruder, which forms strands that may be cut or broken into pellets. The compounder may have a single inlet for introducing the filler and the polymer resin together. Alternatively, separate inlets may be provided for the filler and the polymer resin. Suitable compounders are available commercially, such as, for example, from Werner & Pfleiderer. According to some embodiments, high shear compounding may be used and may result in improved dispersion of the kaolin.

According to some embodiments, the polymer composite composition may be compounded with other components or additives known in the thermoplastic polymer compounding art, such as, for example, stabilizers and/or other additives that include coupling agents, acid scavengers, and metal deactivators. Acid scavenger additives have the ability to neutralize acidic species in a formulation and may be used to improve the stability of the polymer article. Suitable acid scavengers include metallic stearates, hydrotalcite, hydrocalumite, and zinc oxide. Suitable coupling agents include silanes. The stabilizers may include one or more of thermo-oxidative stabilizers and photostabilizers. Thermo-oxidative stabilizers may include anti-oxidants and process stabilizers. Photostabilizers include UV absorbers and UV stabilizers. Some UV stabilizers, such as, for example, hindered amine light stabilizers (HALS), may also be characterized as thermo-oxidative stabilizers.

According to some embodiments, the polymer composite composition may be processed to form or to be incorporated in articles in a number of suitable ways. Such processing may include compression molding, injection molding, gas-assisted injection molding, vacuum forming, thermoforming, extrusion, blow molding, drawing, spinning, film forming, laminating, or any combination thereof. Any suitable apparatus may be used.

The polymer composite compositions disclosed herein may be used to form articles of manufacture for which desirable characteristics may include high stiffness, resistance to solvents, barrier properties, high reflectivity surfaces, heat resistance, high impact strength, and/or resistance to creep. For example, the polymer composite compositions may be used to form articles, such as, for example, aircraft parts, boat hulls, automobile parts (e.g., under-the-hood parts such as engine covers, exterior mirrors, fuel caps, etc.), bath tubs, enclosures, swimming pools, hot tubs, septic tanks, water tanks, roofing materials, pipes, claddings, watersport devices, and external door skins. Other types of articles are contemplated. Such articles may be formed using processes known to those skilled in the respective arts.

### EXAMPLE 1

Fifteen polymer composite test samples and a control polymer test sample were prepared for testing Young's modulus (GPa), ultimate tensile strength (UTS) (MPa), elongation at break (mm), flexural modulus (GPa), flexural strength (MPa), and impact strength (ft-lb/in²). The test samples include nylon as the polymer and one of five sample kaolins (Kaolins A-E), each at 10 wt %, 20 wt %, and 30 wt % loading relative to the total weight of the polymer composite composition sample. Table 1 below provides characteristics of each of the test samples, including characteristics of the kaolin samples. The control sample included nylon but no kaolin.

TABLE 1

| | | Loading | | | Shape |
|---|---|---|---|---|---|
| Sample | Kaolin | (wt %) | hydrous/calcined | d50 (μm) | Factor |
| Control | None | 0 | | | |
| 1 | Kaolin A | 10 | calcined | 1.2 | |
| 2 | Kaolin B | 10 | hydrous | 0.24 | 15 |
| 3 | Kaolin C | 10 | platy hydrous | 1.2 | 100 |
| 4 | Kaolin D | 10 | calcined | 1.5 | |
| 5 | Kaolin E | 10 | calcined | 1.4 | |
| 6 | Kaolin A | 20 | calcined | 1.2 | |
| 7 | Kaolin B | 20 | hydrous | 0.24 | 15 |
| 8 | Kaolin C | 20 | platy hydrous | 1.2 | 100 |
| 9 | Kaolin D | 20 | calcined | 1.5 | |
| 10 | Kaolin E | 20 | calcined | 1.4 | |
| 11 | Kaolin A | 30 | calcined | 1.2 | |
| 12 | Kaolin B | 30 | hydrous | 0.24 | 15 |
| 13 | Kaolin C | 30 | platy hydrous | 1.2 | 100 |
| 14 | Kaolin D | 30 | calcined | 1.5 | |
| 15 | Kaolin E | 30 | calcined | 1.4 | |

Each of the samples was formed using melt mixing and injection molding. The nylon was placed in a DFA-7000 vacuum oven for four hours at 80° C. An Xplore 15 cc Twin Screw Compounder and an Xplore 10 cc Injection Moulding Machine was used to fabricate each of the samples. The melting and mold temperatures were 230° C. and 85° C., respectively.

The tensile testing method was based on ASTM Standards Test Methods for Tensile Properties of Plastics (D638). An Instron 5567 Material Testing System was used to measure the test data. A 5 kN load cell was used, and the extension of the samples was set to 5 mm/min. The test was set to end at a load drop of 90% of the peak load. The extensometer was set to be removed when the tensile strain hit 1.0% for 30 wt % of kaolin and 1.5% for 0%, 10 wt %, and 20 wt % loading. The flexural properties were determined using three-point bending according to ASTM.

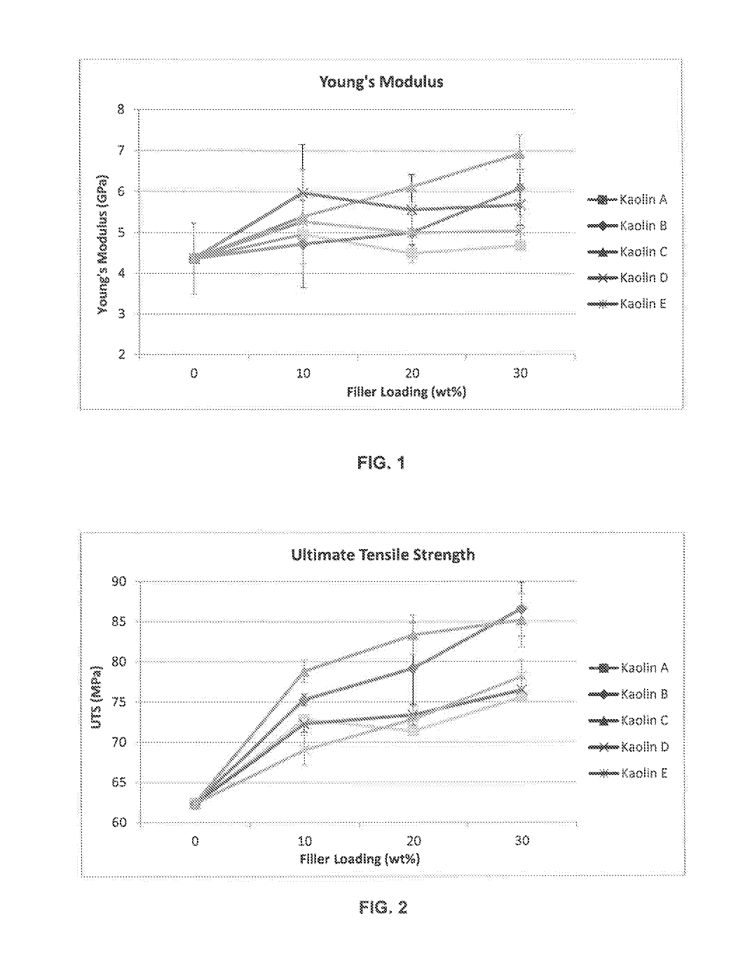

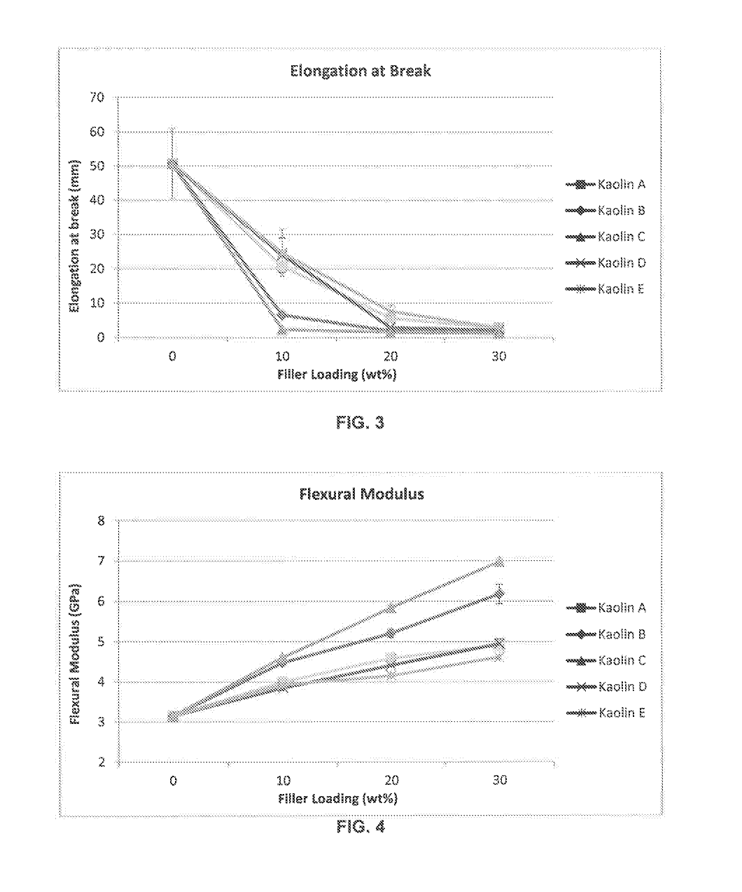

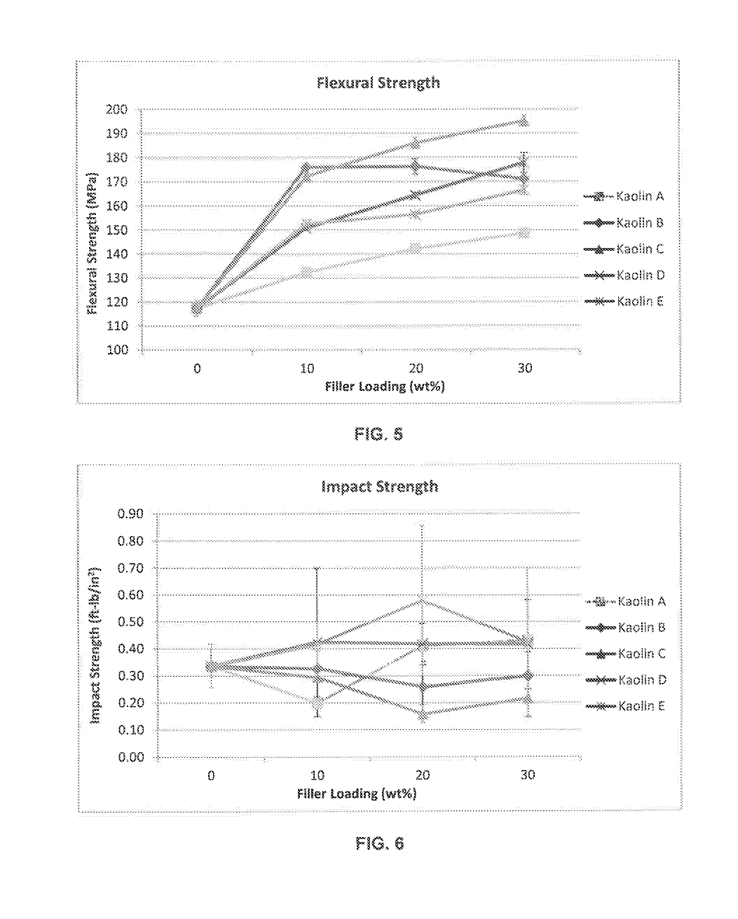

Tables 2-7 below provide the data from the testing, and FIGS. 1-6 are graphs corresponding to the data shown in Tables 2-7. As can be seen from the data, the platy kaolin of Samples 3, 8, and 13 provided superior results at almost all loading levels, with improved results as the loading level increased.

TABLE 2

| | | Loading | Young's |
|---|---|---|---|
| Sample | Kaolin | (wt %) | Modulus (GPa) |
| Control | None | 0 | 4.36 ± 0.87 |
| 1 | Kaolin A | 10 | 4.96 ± 0.64 |
| 2 | Kaolin B | 10 | 4.72 ± 0.07 |
| 3 | Kaolin C | 10 | 5.39 ± 1.16 |
| 4 | Kaolin D | 10 | 5.97 ± 1.18 |
| 5 | Kaolin E | 10 | 5.27 ± 1.26 |
| 6 | Kaolin A | 20 | 4.49 ± 0.37 |
| 7 | Kaolin B | 20 | 5.00 ± 0.44 |
| 8 | Kaolin C | 20 | 6.12 ± 0.25 |
| 9 | Kaolin D | 20 | 5.56 ± 0.86 |
| 10 | Kaolin E | 20 | 5.00 ± 0.74 |
| 11 | Kaolin A | 30 | 4.68 ± 0.42 |
| 12 | Kaolin B | 30 | 6.08 ± 0.46 |
| 13 | Kaolin C | 30 | 6.93 ± 0.47 |
| 14 | Kaolin D | 30 | 5.68 ± 03.5 |
| 15 | Kaolin E | 30 | 5.04 ± 0.37 |

TABLE 3

| | | Loading | |
|---|---|---|---|
| Sample | Kaolin | (wt %) | UTS (MPa) |
| Control | None | 0 | 62.35 ± 0.71 |
| 1 | Kaolin A | 10 | 72.85 ± 0.53 |
| 2 | Kaolin B | 10 | 75.30 ± 0.69 |
| 3 | Kaolin C | 10 | 78.83 ± 1.40 |
| 4 | Kaolin D | 10 | 72.29 ± 1.02 |
| 5 | Kaolin E | 10 | 69.03 ± 1.85 |
| 6 | Kaolin A | 20 | 71.38 ± 1.55 |
| 7 | Kaolin B | 20 | 79.15 ± 5.74 |
| 8 | Kaolin C | 20 | 83.33 ± 2.43 |
| 9 | Kaolin D | 20 | 73.40 ± 1.31 |
| 10 | Kaolin E | 20 | 72.86 ± 1.66 |
| 11 | Kaolin A | 30 | 75.57 ± 1.40 |
| 12 | Kaolin B | 30 | 86.55 ± 3.39 |
| 13 | Kaolin C | 30 | 85.16 ± 3.35 |
| 14 | Kaolin D | 30 | 76.46 ± 1.43 |
| 15 | Kaolin E | 30 | 78.12 ± 2.08 |

TABLE 4

| | | Loading | Elongation at |
|---|---|---|---|
| Sample | Kaolin | (wt %) | Break (mm) |
| Control | None | 0 | 50.70 ± 10.27 |
| 1 | Kaolin A | 10 | 20.71 ± 2.78 |
| 2 | Kaolin B | 10 | 6.58 ± 0.65 |
| 3 | Kaolin C | 10 | 2.40 ± 0.13 |
| 4 | Kaolin D | 10 | 23.95 ± 5.09 |
| 5 | Kaolin E | 10 | 24.66 ± 6.82 |
| 6 | Kaolin A | 20 | 5.63 ± 1.02 |
| 7 | Kaolin B | 20 | 2.02 ± 0.24 |
| 8 | Kaolin C | 20 | 1.57 ± 0.03 |
| 9 | Kaolin D | 20 | 2.98 ± 0.33 |
| 10 | Kaolin E | 20 | 7.62 ± 1.73 |
| 11 | Kaolin A | 30 | 2.82 ± 0.66 |
| 12 | Kaolin B | 30 | 1.36 ± 0.09 |
| 13 | Kaolin C | 30 | 1.19 ± 0.02 |
| 14 | Kaolin D | 30 | 2.19 ± 0.19 |
| 15 | Kaolin E | 30 | 2.89 ± 0.51 |

TABLE 5

| | | Loading | Flex Strength |
|---|---|---|---|
| Sample | Kaolin | (wt %) | (MPa) |
| Control | None | 0 | 117.42 ± 3.26 |
| 1 | Kaolin A | 10 | 132.37 ± 1.12 |
| 2 | Kaolin B | 10 | 175.95 ± 0.95 |
| 3 | Kaolin C | 10 | 172.17 ± 1.66 |
| 4 | Kaolin D | 10 | 150.91 ± 0.97 |
| 5 | Kaolin E | 10 | 152.63 ± 1.65 |
| 6 | Kaolin A | 20 | 142.16 ± 0.84 |
| 7 | Kaolin B | 20 | 176.29 ± 3.13 |
| 8 | Kaolin C | 20 | 186.00 ± 2.44 |
| 9 | Kaolin D | 20 | 164.43 ± 1.14 |
| 10 | Kaolin E | 20 | 156.53 ± 0.95 |
| 11 | Kaolin A | 30 | 148.74 ± 1.42 |
| 12 | Kaolin B | 30 | 171.11 ± 5.64 |
| 13 | Kaolin C | 30 | 195.15 ± 2.4 |
| 14 | Kaolin D | 30 | 177.78 ± 4.13 |
| 15 | Kaolin E | 30 | 166.44 ± 1.94 |

TABLE 6

| | | Loading | Flexural |
|---|---|---|---|
| Sample | Kaolin | (wt %) | Modulus (GPa) |
| Control | None | 0 | 3.15 ± 0.08 |
| 1 | Kaolin A | 10 | 4.00 ± 0.05 |
| 2 | Kaolin B | 10 | 4.48 ± 0.06 |
| 3 | Kaolin C | 10 | 4.61 ± 0.06 |
| 4 | Kaolin D | 10 | 3.85 ± 0.06 |
| 5 | Kaolin E | 10 | 3.93 ± 0.08 |
| 6 | Kaolin A | 20 | 4.59 ± 0.07 |
| 7 | Kaolin B | 20 | 5.21 ± 0.1 |
| 8 | Kaolin C | 20 | 5.84 ± 0.08 |
| 9 | Kaolin D | 20 | 4.41 ± 0.04 |
| 10 | Kaolin E | 20 | 4.15 ± 0.05 |
| 11 | Kaolin A | 30 | 4.91 ± 0.04 |
| 12 | Kaolin B | 30 | 6.18 ± 0.24 |
| 13 | Kaolin C | 30 | 6.98 ± 0.07 |
| 14 | Kaolin D | 30 | 4.95 ± 0.12 |
| 15 | Kaolin E | 30 | 4.62 ± 0.06 |

TABLE 7

| | | Loading | Impact Strength |
|---|---|---|---|
| Sample | Kaolin | (wt %) | (ft-lb/in²) |
| Control | None | 0 | 38.96 ± 9.38 |
| 1 | Kaolin A | 10 | 22.85 ± 4.31 |
| 2 | Kaolin B | 10 | 37.85 ± 12.05 |
| 3 | Kaolin C | 10 | 34.04 ± 11.68 |
| 4 | Kaolin D | 10 | 49.52 ± 14.25 |
| 5 | Kaolin E | 10 | 48.18 ± 9.71 |
| 6 | Kaolin A | 20 | 47.62 ± 8.54 |
| 7 | Kaolin B | 20 | 29.89 ± 10.98 |
| 8 | Kaolin C | 20 | 18.32 ± 3.84 |
| 9 | Kaolin D | 20 | 48.36 ± 8.9 |
| 10 | Kaolin E | 20 | 67.02 ± 32.29 |
| 11 | Kaolin A | 30 | 49.8 ± 10.75 |
| 12 | Kaolin B | 30 | 34.73 ± 10.21 |
| 13 | Kaolin C | 30 | 24.99 ± 8.12 |
| 14 | Kaolin D | 30 | 48.25 ± 19.3 |
| 15 | Kaolin E | 30 | 49.17 ± 31.87 |

### EXAMPLE 2

Eight polymer composite test samples were prepared for physical testing using ASTM International and International Organization for Standardization (ISO) standards. Each test sample comprised nylon, chopped glass fibers (10 micron), and a kaolin-based mineral product. Specifically, samples A and B contained Translink 445 (a Kaolin-based product commercially available from BASF corporation). Sample C contained calcined kaolin clay treated with a single amino silane (3-amino propyl triethoxysilane) at 0.5% concentration. Samples D and J contained hyperlaty kaolin clay with a Malvern D50 of 1.1 μm and a shape factor of 100 treated with a dual amino silane (2-aminoethyl-3-amino-propyltrimethoxysilane) at 1.0% concentration. Sample E contained hyperlaty kaolin clay with a Malvern D50 of 3.5 μm and a shape factor of 60 treated with dual amino silane at 1% concentration. Sample F contained hyperlaty kaolin clay with a Malvern D50 of 1.1 μm and a shape factor of 100 treated with 0.5% single amino silane. Samples G and H contained hyperlaty kaolin clay with a Malvern D50 of 3.5 μm and a shape factor of 60 treated with 0.5% single amino silane. And sample I contained super ultrafine kaolin clay with a laser D50 of 0.13 μm treated with 0.5% single amino silane. All samples of the were prepared to include 15% glass fiber and 25% mineral product by weight, but, as summarized in Tables 8 and 9 below, analysis of the filler content varied when the samples were tested.

The samples were each subjected to eight tests, the results of which are summarized in Tables 8 and 9 below. As can be seen from the data, samples E and H provided superior tensile strength and elongation results.

TABLE 8

| | Sample | Sample | Sample | Sample | Sample |
|---|---|---|---|---|---|
| Properties | A | B | C | D | E |
| Filler Content (%) | 39.8 | 38.7 | 40.3 | 28.0 | 36.2 |
| Moisture (%) | 0.055 | 0.01 | 0.070 | 0.093 | 0.09 |
| Tensile Strength | 126 | 131 | 123 | 137 | 143 |
| (MPa) | | | | | |
| Tensile | 3.9 | 3.3 | 3.0 | 2.7 | 2.5 |
| Elongation | | | | | |
| at Break (%) | | | | | |
| Flex Modulus | 7256 | 6950 | 7288 | 7010 | 8590 |
| Chord (MPa) | | | | | |
| Flex Strength | 203 | 203 | 195 | 190 | 209 |
| (MPa) | | | | | |
| Charpy Notched | 4.0 | 5.6 | 3.5 | 4.5 | 5.4 |
| (KJ/m²) | | | | | |
| Charpy | 52 | 49.5 | 53 | 44 | 48.5 |
| Unnotched | | | | | |
| (KJ/m²) | | | | | |

TABLE 9

| Properties | Sample F | Sample G | Sample H | Sample I | Sample J |
|---|---|---|---|---|---|
| Filler | 33.0 | 37.1 | 35.3 | 34.5 | 25.5 |
| Content | | | | | |
| (%) | | | | | |
| Moisture (%) | 0.009 | 0.058 | 0.003 | 0.074 | 0.086 |
| Tensile | 134 | 134 | 145 | 137 | 122 |
| Strength | | | | | |
| Tensile | 2.3 | 2.4 | 2.6 | 2.9 | 3.0 |
| Elongation at | | | | | |
| Break (%) | | | | | |
| Flex | 7740 | 8750 | 8245 | 7012 | 6539 |
| Modulus | | | | | |
| Chord (MPa) | | | | | |
| Flex | 188 | 202 | 212 | 190 | 174 |
| Strength | | | | | |
| (MPa) | | | | | |
| Charpy | 5.2 | 3.9 | 5.3 | 4.1 | 4.3 |
| Notched | | | | | |
| (KJ/m²) | | | | | |
| Charpy | 45 | 43 | 49 | 50 | 41 |
| Unnotched | | | | | |
| (KJ/m²) | | | | | |

Filler content was tested using ASTM D5630 (1500° F./10 mins) and moisture content was tested using ASTM D6980 (at a temperature of 180° F.). Tensile strength and elongation were both tested using ISO 527 at a rate of 50 mm/min. Rex modulus chord and flex strength were tested using ISO 178 at a rate of 2 mm/min. And impact strength was assessed at 23° C. using ISO 179. Both Charpy notched and Charpy unnotched tests were run.

Other embodiments will be apparent to those skilled in the art from consideration of the specification and practice of the embodiments disclosed herein. It is intended that the specification and examples be considered as exemplary only.

1. A polymer composite composition for manufacturing an article, the composition comprising:
hydrous kaolin;
an acicular material; and
a polymer comprising at least one of nylons, polyesters, polyimides, polyamides, aromatic polyamides, polysulfides, polyetherketones, polycarbonates, and polyolefins, wherein the hydrous kaolin, acicular material, and polymer are combined to form the polymer composite composition.

2. The composition of claim 1, wherein the hydrous kaolin comprises platy hydrous kaolin.

3. The composition of claim 1, wherein the hydrous kaolin has a shape factor of at least 10.

4. The composition of claim 1, wherein the hydrous kaolin has a shape factor of at least 30.

5. The composition of claim 1, wherein the hydrous kaolin has a shape factor of at least 60.

6. The composition of claim 1, wherein the hydrous kaolin comprises surface-treated hydrous kaolin.

7. The composition of claim 1, wherein the hydrous kaolin comprises hydrous kaolin surface-treated with at least one of silanes, amino silanes, silicates, silicone fluids, emulsions, and siloxanes.

8. The composition of claim 1, wherein the hydrous kaolin comprises hydrous kaolin surface-treated with amino silanes.

9. The composition of claim 1, wherein the acicular material comprises fiber.

10. The composition of claim 1, wherein the acicular material comprises chopped fiber.

11. The composition of claim 1, wherein the acicular material comprises glass fiber or wollastonite.

12. The composition of claim 1, wherein the acicular material comprises chopped glass fiber.

13. The composition of claim 1, wherein the composition comprises at least 10 wt % hydrous kaolin relative to the total weight of the composition.

14. The composition of claim 1, wherein the composition comprises at least 20 wt % hydrous kaolin relative to the total weight of the composition.

15. The composition of claim 1, wherein the composition comprises at least 30 wt % hydrous kaolin relative to the total weight of the composition.

16. The composition of claim 1, wherein the median particle size d₅₀ of the hydrous kaolin is less than or equal to 2 microns.

17. The composition of claim 1, wherein the median particle size d₅₀ of the hydrous kaolin is less than or equal to 1.5 microns.

18. The composition of claim 1, wherein the median particle size d₅₀ of he hydrous kaolin is less than or equal to 1.0 micron.

19. The composition of claim 1, wherein the median particle size d₅₀ of the hydrous kaolin is less than or equal to 0.5 microns.

20. The composition of claim 1, wherein the median particle size d₅₀ of the hydrous kaolin is less than or equal to 0.5 microns, and the hydrous kaolin comprises hydrous kaolin surface-treated with amino silanes.

21-36. (canceled)
